(19) United States
(12) Patent Application Publication
(10) Pub. No.: US 2022/0178317 A1
(43) Pub. Date: Jun. 9, 2022

(54) METHOD FOR CONTROLLING A BOOST PRESSURE OF AN ENGINE

(71) Applicant: Robert Bosch GmbH, Stuttgart (DE)

(72) Inventors: Andre Wittmer, Holzkirchen (DE); Linus Carle, Bad Aibling (DE)

(21) Appl. No.: 17/457,335

(22) Filed: Dec. 2, 2021

(30) Foreign Application Priority Data
Dec. 8, 2020 (DE) 10 2020 215 462.7

(51) Int. Cl. F02D 41/00; F02B 37/16; F02B 39/10

(52) U.S. Cl. CPC F02D 41/0007; F02B 39/10; F02B 37/16

(57) ABSTRACT

A method for controlling a boost pressure of an engine, which includes a charging device including a compressor and a compressor bypass, the compressor bypass including a blow off valve for opening and closing the compressor bypass. A boost pressure control uses an actual boost pressure and a setpoint boost pressure as input parameters. A first compressor pressure ratio is ascertained based on a limit line from a compressor characteristic map and an engine absorption characteristic for the engine. A second compressor pressure ratio is ascertained based on the limit line, a mass flow, and a throttle characteristic curve for the blow off valve. A maximum permissible compression ratio for the compressor is ascertained from the first and second compressor pressure ratios. A maximum permissible boost pressure is ascertained as a function of the maximum permissible compression ratio. The boost pressure control is limited to the maximum permissible boost pressure.

### BACKGROUND INFORMATION

In engines and, in particular, combustion engines, such as for example gasoline and diesel engines, the air charge in the combustion chamber of the engine is increased with the aid of a compressor to increase the power, such as for example with the aid of an exhaust gas turbocharger or a purely electric compressor. The pressure at which the air in the combustion chamber of the engine is compressed is also referred to as the boost pressure. The boost pressure is regulated in the process in a conventional manner by way of a boost pressure control, usually an actual boost pressure being adjusted to a setpoint boost pressure.

German Patent Application No. DE 10 2012 224 055 A1 describes a method for controlling a boost pressure of an engine 10. Engine 10 includes a compressor 18, in particular, a turbocharger 34. The control uses an actual boost pressure and a setpoint boost pressure as input parameters. The setpoint boost pressure is controlled in such a way that a pressure ratio in compressor 18 does not exceed a limiting pressure ratio. A reference boost pressure is ascertained based on a rotational speed of engine 10 and a load of engine 10. A flow and/or a pressure of air supplied to engine 10 is detected, and an associated flow signal and/or pressure signal is generated. The smaller pressure of the reference boost pressure and a limiting boost pressure is used as the setpoint boost pressure. The method is characterized in that a limiting boost pressure ratio is ascertained based on a variable of a temporal change of the flow signal and/or of the pressure signal, the limiting boost pressure being ascertained based on the limiting boost pressure ratio and a rotational speed of compressor 18. Furthermore, an engine 10 including a compressor 18, in particular, a turbocharger 34, and including a control device 32 is described, control device 32 being configured to carry out such a method.

### SUMMARY

In a first aspect of the present invention, a method for controlling a boost pressure of an engine is provided, the engine including a charging device including a compressor and a compressor bypass, compressor bypass 65 including a blow off valve for opening and closing the compressor bypass. A boost pressure control uses an actual boost pressure and a setpoint boost pressure as input parameters. In accordance with an example embodiment of the present invention, a first compressor pressure ratio is ascertained as a function of a limit line from a compressor characteristic map and an engine absorption characteristic for the engine and a second compressor pressure ratio being ascertained as a function of the limit line from the compressor characteristic map, a mass flow through the engine and a throttle characteristic curve for the blow off valve, a maximum permissible compression ratio for the compressor being ascertained from the first and second compressor pressure ratios, a maximum permissible boost pressure being ascertained as a function of the maximum permissible compression ratio, and the boost pressure control being limited to the maximum permissible boost pressure.

The example method of the present invention, in particular, has the advantage that a control for the charging device through the ascertainment of the maximum permissible compressor pressure ratio may be carried out in such a way that it is always possible to set a boost pressure at which the compressor, with an open blow off valve, is operated in the safe characteristic map range below its surge limit. As a result of this limitation of the boost pressure, a component protection for the charging device may be obtained.

The example method furthermore has the advantage that it is always possible to set a maximum boost pressure, taking the maximum permissible compression ratio into consideration, in transient operating states for the engine.

The example method furthermore offers the advantage that the implementation of the method for controlling the boost pressure requires few resources and little computing time on the control device, since the ascertainment of the intersecting points for the compression ratios takes place from data which are already stored in characteristic maps, such as e.g. the compressor characteristic map, the throttle characteristic curve for the blow off valve, and the absorption characteristic for the engine. These characteristic maps are largely already ascertained during an application phase for the corresponding components and stored in the control device.

In accordance with an example embodiment of the present invention, furthermore, a first intersecting point between the engine absorption characteristic and the limit line may be ascertained from the compressor characteristic map for calculating the first compressor pressure ratio.

The example method of the present invention offers the advantage that the implementation of the method for controlling the boost pressure requires few resources and little computing time on the control device, since the ascertainment of the first intersecting point for the compression ratio takes place from data which are already stored in characteristic maps, such as e.g. the limit line and the engine absorption characteristic for the engine.

In accordance with an example embodiment of the present invention, furthermore, the throttle characteristic curve may be shifted by the instantaneous mass flow through the engine in the direction of the abscissa, i.e., on the mass flow axis, and a second intersecting point between the shifted throttle characteristic curve and the limit line is ascertained from the compressor characteristic map for calculating the second compressor pressure ratio.

The example method offers the advantage that the implementation of the method for controlling the boost pressure requires few resources and little computing time on the control device, since the ascertainment of the second intersecting point for the second compressor pressure ratio takes place from data which are already stored in characteristic maps, such as e.g. the limit line and the throttle characteristic curve for the engine.

It is advantageous when the maximum permissible compressor pressure ratio is ascertained as a minimum between the first compressor pressure ratio and the second compressor pressure ratio.

The method has the particular advantage that a control for the charging device may be carried out through the ascertainment of the maximum permissible compressor pressure ratio in such a way that it is always possible to set a boost pressure at which the compressor, with an open blow off valve, is operated in the safe characteristic map range below its surge limit. As a result of this limitation of the boost pressure, a component protection for the charging device may be obtained.

Furthermore, the charging device may be configured as an exhaust gas turbocharger or as an electrically charged exhaust gas turbocharger or as an electric compressor.

The engine may furthermore be designed as a combustion engine or as a fuel cell.

The actual boost pressure may furthermore be set with the aid of the throttle valve and/or the electric machine of the charging device and/or of an exhaust gas turbocharger and/or of an electrically supported exhaust gas turbocharger and/or of the blow off valve.

The blow off valve may furthermore be partially or completely open. It is advantageous when a minimum mass flow, in particular, a mass flow greater than 0 kg/s, flows across the blow off valve.

In further aspects, the present invention relates to a device, in particular, a control device, and a computer program, which are configured, in particular, programmed, to carry out one of the methods. In yet another aspect, the present invention relates to a machine-readable memory medium on which the computer program is stored.

### BRIEF DESCRIPTION OF THE DRAWINGS

The present invention is described in greater detail hereafter with reference to the figures and based on exemplary embodiments.

FIG. 1 shows a schematic representation of a motor vehicle 1 including a combustion engine 10.

FIG. 2 shows the exemplary sequence of the method based on a flowchart in a preferred specific embodiment of the present invention.

### DETAILED DESCRIPTION OF EXAMPLE EMBODIMENTS

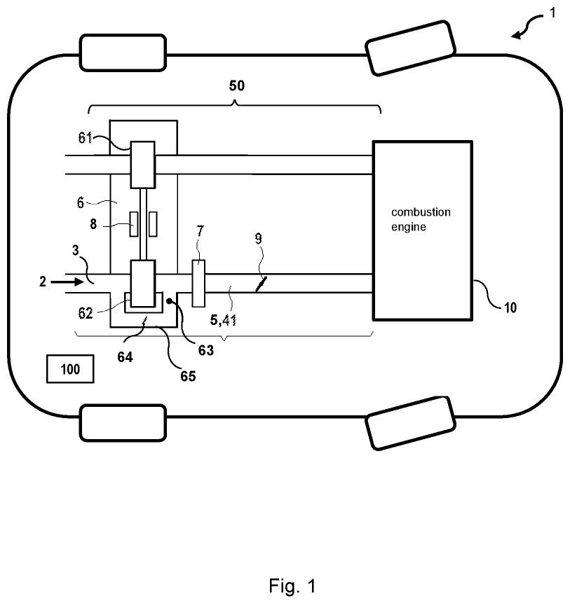

FIG. 1 shows a motor vehicle 1 including an engine 10 in the form of a combustion engine. The present exemplary embodiment shows a four-cylinder combustion engine 10 without limitation.

Combustion engine 10 may preferably be designed as a diesel or gasoline engine. The method may also be carried out with combustion engines including an arbitrary number of cylinders, preferably including 2, 3, 6, 8 cylinders.

The exemplary embodiment may also be applied to charged engines, in particular, to a charged fuel cell which electrically drives motor vehicle 1.

Within the scope of the present invention, a fuel cell shall be understood to mean a galvanic cell, which converts chemical reaction energy of a fuel supplied via a fuel supply line and of an oxidizing agent into electrical energy. The fuel may be hydrogen or methane or methanol. The oxidizing agent is usually air or oxygen. Accordingly, water vapor or water vapor and carbon dioxide is/are created as exhaust gas.

Combustion engine 10 is supplied with ambient air in a conventional manner via an air supply system 40, and combustion exhaust gas is removed from cylinders 23 via an exhaust gas system 50. Air supply system 40 is connected in a conventional manner via intake valves (not shown) to cylinders 23 of combustion engine 10. Combustion exhaust gas is discharged via corresponding discharge valves (not shown) into exhaust gas system 50 in a conventional manner.

The following are situated in the flow direction of air 2: A first sensor 3, e.g., a hot film air mass meter 3 (HEM), a charging device 6, which includes an exhaust gas turbine 61 in exhaust gas system 50, and a compressor 62 including a compressor bypass 65 in air supply system 40.

First sensor 3 may determine a first pressure p₁, a first temperature T₁ and a first mass flow \dot{m}₁. As an alternative or in addition, a sensor may also be installed in each case for every system variable. It is also possible to ascertain the measuring variables with the aid of models which are calculated on control device 100.

Charging device 6 is designed as an electrically supported exhaust gas turbocharger 6. Turbine 61 is mechanically coupled to compressor 62 so that exhaust gas enthalpy, which is converted into mechanical energy in turbine 61, is used for the compression of ambient air drawn in from the surroundings in compressor 62.

In addition, charging device 6 may be electrically operated with the aid of an electric machine 8, which is able to introduce additional mechanical energy via a mechanical coupling between turbine 61, compressor 62 and electric machine 8, so that compressor 62 may also be operated independently of the mechanical energy provided by the turbine or also in a supporting manner.

The electric supporting drive may be implemented in various designs, e.g., as a media gap motor upstream from compressor impeller 62 or as a mid-mounted motor between the turbine and the compressor impeller.

A charge air cooler 7 may be provided downstream from compressor 62. The boost pressure in boost section 41 results from the compression power of compressor 62.

Charging air section 41 is delimited downstream by a throttle valve 9. A third sensor 5 is situated downstream from charge air cooler 7 and upstream from throttle valve 9, which is able to ascertain a second pressure p₂ and a second temperature T₂.

A control device 100 is provided, which operates combustion engine 10 in a conventional manner by actuating the actuators, such as for example throttle valve 9, of a charger actuator (not shown) at turbine 61, and the like, corresponding to an instantaneous operating state of combustion engine 10 and corresponding to a specification, for example a driver input torque.

Furthermore, a so-called compressor bypass 65 is connected in parallel to compressor 62. The output for compressor bypass 65 begins upstream from compressor 62, and the input is situated downstream from compressor 62 and upstream from charge air cooler 7. A valve 64 is situated in compressor bypass 65, which is also referred to as a blow off valve 64. When blow off valve 64 is closed, the fresh air mass flow is completely conducted through compressor 62. When blow off valve 64 is open, at least a portion of the fresh air mass flow is conducted past compressor 62. When blow off valve 64 is open, the air typically flows from the side situated downstream to the side situated upstream.

In an alternative specific embodiment of the present invention, the inlet for compressor bypass 65 is situated downstream from charge air cooler 7 and upstream from throttle valve 9. This arrangement has the advantage that air returned to compressor 62 may be cooled.

Turbine 61 of exhaust gas turbocharger 6 may be configured as a turbine having a variable turbine geometry, i.e., as a turbine including adjustable guide vanes.

The effective flow cross-section upstream from the turbine wheel may be varied by a rotation of the guide vanes.

Motor vehicle 1 is furthermore configured with sensors, whose signals may be used to ascertain driving-specific variables for motor vehicle 1. In this way, a gas pedal position w_{pedal}, a rotational speed n_{eng} of combustion engine 10 and a rotational speed n_{charger} of charging device 6 may be ascertained. These signals of the sensors are received by a control device 100 and stored.

Furthermore, a compressor characteristic map V is stored in control device 100 for charging device 6 used. The compressor characteristic map is preferably stored during an application phase in control device 100 for charging device 6.

Furthermore, a limit line or surge limit or rotational speed limit for charging device 6 is stored in a characteristic map.

The surge of the compressor, also referred to as compressor surge for short, shall be understood within the framework of the present invention as an operating state which is potentially dangerous for the structural integrity of compressor 62. There are operating points for charging device 6, flow separations occurring at the compressor blades of the compressor. As a result, the compressor power decreases. In the event that the pressure, which has built up downstream from or behind the compressor, exceeds the pressure which the compressor generates, an effect occurs which reverses the flow of the air. During this back-flow, the pressure decreases downstream from the compressor outlet, the flow reverses again and flows out of the compressor outlet again in the original direction. This interplay is referred to as surge, which results in considerable cyclical loads on the compressor and may result in its destruction. Measures for reducing this behavior are referred to as surge protection.

Blow off valve 64 and compressor bypass 65 behave as a unit, viewed like a throttle point in a pipe. The behavior of such an arrangement is well-documented in the literature. There are different types, either as a diaphragm including an empirically ascertained flow coefficient (see also DIN EN ISO 5167-1:2004), or as a nozzle flow including an appropriate nozzle cross-section. In any case, a behavior is obtained in which:

1. the mass flow increases with a rising pressure ratio;

2. the increase in the mass flow decreases with increasing pressure ratio.

During an application phase, a throttle characteristic curve D is ascertained for blow off valve 64, including the pipes of compressor bypass 65, as a curve of the compressor pressure ratio across blow off valve 64 compared to mass flow invent across blow off valve 64.

This throttle characteristic curve D for blow off valve 64 may correspond to the curve of a throttle function ƒ, which is dependent on effective cross-sectional surface A_{eff} of blow off valve 64, the temperature at the inlet of blow off valve 64, and the pressures at inlet 63 and at the outlet of compressor bypass 65.

During stationary operation, throttle characteristic curve D may be ascertained from the compressor pressure ratio and the difference between mass flow \dot{m}_{cmpr} across compressor 62 and the measured hot film air mass flow or the fresh air mass flow across throttle valve 9. With a known compressor characteristic map V, mass flow \dot{m}_{cmpr} across compressor 62 may be ascertained from the state variables of compressor 62 around which the flow occurs, rotational speed n_{charger}, a compressor pressure ratio and first temperature T₁ and pressure p₁ at the inlet into compressor 62.

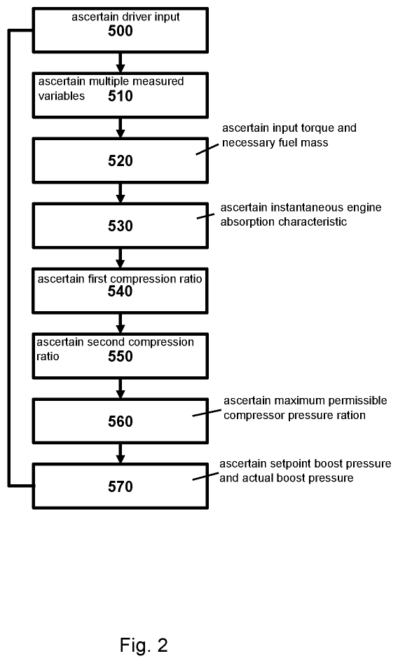

FIG. 2 shows the exemplary sequence of the method for ascertaining a boost pressure control for a combustion engine 10 based on a flowchart.

In a first step 500, a driver input for motor vehicle 1 is ascertained, preferably via gas pedal position w_{pedal}. Gas pedal position w_{pedal} is received as a signal by a control device 100 and is stored. Thereafter, the method is continued in a step 510.

In a step 510, multiple measured variables are ascertained for motor vehicle 1. Control device 100 receives a first pressure p₁ and a first temperature T₁ upstream from compressor 62 and a second pressure p₂ and a second temperature T₂ downstream from compressor 62, as well as a rotational speed n_{eng} of combustion engine 10, and a rotational speed n_{charger} of charging device 6, and stores them.

As an alternative, second temperature T₂ may also be ascertained downstream from charge air cooler 7, i.e., by a temperature sensor which is situated downstream from charge air cooler 7 and upstream from combustion engine 10. With the aid of a temperature model, which is ascertained on control device 100, a temperature T₂ upstream from the charge air cooler is then calculated.

Thereafter, the method is continued in a step 520.

In a step 520, an input torque and the necessary fuel mass flow q are ascertained with the aid of a model implemented on control device 100 for the torque structure of motor vehicle 1, taking gas pedal position w_{pedal} ascertained in step 500 into consideration. Thereafter, the method may be continued in step 530.

In a step 530, an instantaneous engine absorption characteristic S for combustion engine 10 is ascertained by control device 100 as a function of rotational speed n_{eng} of combustion engine 10, an air requirement λₐ for combustion engine 10, a displacement V_{H} of combustion engine 10, second temperature T₂ downstream from compressor 62, general gas constant R and pressure p₂ downstream from compressor 62.

As an alternative, instantaneous engine absorption characteristic S may also be ascertained as a function of a pressure ratio

$${\prod }_{V} = \frac{{p}_{2}}{{p}_{1}}$$

across compressor 62 and a corrected volume flow \dot{V}_{corr} across compressor 62:

$$S = \frac{{\prod }_{V}}{{\dot{V}}_{corr}}$$

$$where {\dot{V}}_{corr} = {\dot{V}}_{1} \cdot \sqrt{\frac{{T}_{Ref}}{{T}_{1}}}$$

where p₁ is the first pressure upstream from compressor 62 and p₂ is the second pressure downstream from compressor 62.

Corrected volume flow \dot{V}_{corr} results from volume flow \dot{V}₁, first temperature T₁ upstream from compressor 62, and a reference temperature T_{ref}, which are ascertained during an application phase for charging device 6 and stored in control device 100.

The following relationship exists between corrected volume flow \dot{V}_{corr} and a corrected mass flow \dot{m}_{corr}:

$${\dot{m}}_{corr} = {\dot{V}}_{corr} \cdot {ρ}_{1}$$

where ρ₁ is the density of the air upstream from compressor 62, p₁ is the pressure upstream from compressor 62, and p₂ is the pressure downstream from compressor 62.

Thereafter, the method is continued in step 540.

In a step 540, a first compressor pressure ratio Π₁ is ascertained as a function of absorption characteristic S ascertained in step 530 and the known surge limit from compressor characteristic map V. In the process, a first intersecting point S₁ of absorption characteristic S with a limit line L is ascertained with the aid of control device 100 and stored. As was already described, compressor characteristic map V in control device 100 is preferably stored during an application phase in control device 100 for charging device 6, a surge limit dividing the operation of charging device 6 into a stable range and an unstable range. This surge limit is also referred to as a limit line L.

Thereafter, the method is continued in a step 550.

In a step 550, a second compressor pressure ratio Π₂ is ascertained as a function of the instantaneously ascertained mass flow \dot{m}ₘₒₜₒᵣ through combustion engine 10 and throttle characteristic curve D for blow off valve 64. In the process, instantaneous mass flow \dot{m}ₘₒₜₒᵣ serves as an offset for throttle characteristic curve D of blow off valve 64, throttle characteristic curve D being shifted in the direction of the abscissa, i.e., on the mass flow axis, by instantaneous mass flow \dot{m}ₘₒₜₒᵣ through combustion engine 10. Proceeding from throttle characteristic curve D shifted by the offset, a second intersecting point S₂ with limit line L is then ascertained. This second intersecting point S₂ yields second compressor pressure ratio Π₂.

Thereafter, the method is continued in a step 560.

In a step 560, a maximum permissible compressor pressure ratio Πₘₐₓ is ascertained as a minimum from first compressor pressure ratio Π₁ and second compressor pressure ratio Π₂.

The boost pressure may be raised up to this maximum permissible compressor pressure ratio Πₘₐₓ for a current load of combustion engine 10.

With the aid of the inclination of throttle valve 9, the load of combustion engine 10 is set in such a way that a surge event for compressor 62 occurs neither in stationary operation nor during a sudden load variation, after throttle valve 9 has been opened and blow off valve 64 has been closed approximately at the same time, if it was previously opened. This means that a setpoint boost pressure pₛₑₜₚₒᵢₙₜ for the boost pressure control is always defined in a safe characteristic map range.

Thereafter, the method is continued in step 570.

In a step 570, a setpoint boost pressure pₛₑₜₚₒᵢₙₜ and an actual boost pressure p_{actual} are ascertained by way of boost pressure control, actual boost pressure p_{actual} being subsequently controlled to setpoint boost pressure pₛₑₜₚₒᵢₙₜ.

A maximum permissible boost pressure pₘₐₓ is ascertained as a function of maximum permissible compressor pressure ratio Πₘₐₓ ascertained in step 580.

Maximum permissible boost pressure pₘₐₓ may be ascertained as follows for charging device 6:

$${p}_{max} = {\prod }_{max} \cdot {p}_{1} ,$$

where Πₘₐₓ is the maximum permissible compressor pressure ratio and p₁ is the first pressure upstream from compressor 62.

If setpoint boost pressure pₛₑₜₚₒᵢₙₜ exceeds maximum permissible boost pressure pₘₐₓ, the boost pressure control adopts maximum permissible boost pressure pₘₐₓ as the setpoint boost pressure.

If setpoint boost pressure pₛₑₜₚₒᵢₙₜ falls below maximum permissible boost pressure pₘₐₓ, additional degrees of freedom arise for a dynamic boost pressure control since boost pressures between pₛₑₜₚₒᵢₙₜ≤x≤pₘₐₓ may now be set for setpoint boost pressure pₛₑₜₚₒᵢₙₜ.

Thereafter, actual boost pressure p_{actual} upstream from throttle valve 9, preferably upstream from throttle valve 9 and downstream from charge air cooler 7, is set to setpoint boost pressure pₛₑₜₚₒᵢₙₜ ascertained by control device 100. This takes place in a conventional manner, preferably via the adjustment of the guide vanes for a VTG exhaust gas turbocharger and/or the adjustment of a turbine bypass for charging device 6 and/or by the activation of electric machine 8 for charging device 6. The charge level necessary for the driver input torque is set at the same time or directly via the adjustment of the opening level of throttle valve 9.

Thereafter, the method may be ended or started again with step 500.

1-11. (canceled)

12. A method for controlling a boost pressure of an engine, the engine including a charging device including a compressor and a compressor bypass, the compressor bypass including a blow off valve configured to open and close the compressor bypass, a boost pressure control using an actual boost pressure and a setpoint boost pressure as input parameters, the method comprising the following steps:
ascertaining a first compressor pressure ratio as a function of a limit line from a compressor characteristic map and an engine absorption characteristic for the engine;
ascertaining a second compressor pressure ratio as a function of the limit line from the compressor characteristic map, a mass flow through the engine, and a throttle characteristic curve for the blow off valve;
ascertaining a maximum permissible compressor pressure ratio for the compressor from the first compressor pressure ratio and the second compressor pressure ratio;
determining a maximum permissible boost pressure as a function of the maximum permissible compression ratio;
limiting the boost pressure control to the maximum boost pressure.

13. The method as recited in claim 12, wherein an intersecting point between the engine absorption characteristic and the limit line is ascertained from the compressor characteristic map for ascertaining the first pressure ratio.

14. The method as recited in claim 12, wherein the throttle characteristic curve is shifted by an instantaneous mass flow through the engine in a direction of an abscissa, the abscissa being a mass flow axis, and a second intersecting point between the shifted throttle characteristic curve and the limit line is ascertained from the compressor characteristic map for ascertaining the second pressure ratio.

15. The method as recited in claim 12, wherein the maximum permissible compressor pressure ratio is ascertained as a minimum between the first compressor pressure ratio and the second compressor pressure ratio.

16. The method as recited in claim 12, wherein the charging device is configured as an exhaust gas turbocharger or as an electrically charged exhaust gas turbocharger or as an electric compressor.

17. The method as recited in claim 12, wherein the engine is a combustion engine or a fuel cell.

18. The method as recited in claim 12, wherein the actual boost pressure is set using the throttle valve and/or an electric machine of the charging device and/or an exhaust gas turbocharger and/or an electrically supported exhaust gas turbocharger and/or the blow off valve.

19. The method as recited in claim 12, wherein the blow off valve is partially or completely open.

20. A non-transitory electronic memory medium on which is stored a computer program for controlling a boost pressure of an engine, the engine including a charging device including a compressor and a compressor bypass, the compressor bypass including a blow off valve configured to open and close the compressor bypass, a boost pressure control using an actual boost pressure and a setpoint boost pressure as input parameters, the computer program, when executed by computer, causing the computer to perform the following steps:
ascertaining a first compressor pressure ratio as a function of a limit line from a compressor characteristic map and an engine absorption characteristic for the engine;
ascertaining a second compressor pressure ratio as a function of the limit line from the compressor characteristic map, a mass flow through the engine, and a throttle characteristic curve for the blow off valve;
ascertaining a maximum permissible compressor pressure ratio for the compressor from the first compressor pressure ratio and the second compressor pressure ratio;
determining a maximum permissible boost pressure as a function of the maximum permissible compression ratio;
limiting the boost pressure control to the maximum boost pressure.

21. A device, comprising:
a control device configured to control a boost pressure of an engine, the engine including a charging device including a compressor and a compressor bypass, the compressor bypass including a blow off valve configured to open and close the compressor bypass, a boost pressure control using an actual boost pressure and a setpoint boost pressure as input parameters, the control device configured to:
ascertain a first compressor pressure ratio as a function of a limit line from a compressor characteristic map and an engine absorption characteristic for the engine;
ascertain a second compressor pressure ratio as a function of the limit line from the compressor characteristic map, a mass flow through the engine, and a throttle characteristic curve for the blow off valve;
ascertain a maximum permissible compressor pressure ratio for the compressor from the first compressor pressure ratio and the second compressor pressure ratio;
determine a maximum permissible boost pressure as a function of the maximum permissible compression ratio;
limit the boost pressure control to the maximum boost pressure.
